(19) United States
(12) Patent Application Publication
(10) Pub. No.: US 2001/0051777 A1
(43) Pub. Date: Dec. 13, 2001

(54) Vibrating massager

(76) Inventor: Junshiro Nakayama, Shinjuku-ku (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/865,502

(22) Filed: May 29, 2001

(30) Foreign Application Priority Data
Jun. 12, 2000 (JP) 2000-174843

(51) Int. Cl. A61H 1/00

(52) U.S. Cl. 601/46

(57) ABSTRACT

A vibrating massager provided with a vibration source, a vibrating member adapted to be vibrated by the vibration source, vibrating protrusions provided on one surface side of the vibrating member; and springs for applying spring force to the vibrating protrusions. With such a configuration, it is possible to provide a vibrating massager by which adjusted vibration pressure is generated with a simple structure.

### FIELD OF THE INVENTION

The present invention relates to a vibrating massager having a simple structure in which a vibrating member pressed against an affected part vibrates to massage and relax the affected part.

### DESCRIPTION OF RELATED ART

Various types of massagers are provided as health appliances for massaging and relaxing an affected stiff part or relieving fatigue. Examples of such massagers include a vibrating type in which a vibrating member vibrates to massage and relax an affected part, a high frequency vibrating type in which a high frequency vibrating mat is put on an affected part, a sandwich type in which a pair of members hold an affected part therebetween to massage and relax the affected part, a hitting or tapping type, and so on.

However, a related-art vibrating-type massager has a structure in which a flat vibrating member is vibrated directly against an affected part. Accordingly, such a related-art vibrating-type massager has a disadvantage that the massager is insufficient in giving an impulse to a pressure point.

### SUMMARY OF THE INVENTION

It is therefore an object of the present invention to provide a vibrating massager which is designed to be applied to a pressure point easily so as to obtain an efficient massage effect.

In order to achieve the above object, according to an aspect of the present invention, there is provided a vibrating massager comprising: a vibration source; a vibrating member adapted to be vibrated by the vibration source; vibrating protrusion means formed on one surface side of the vibrating member; and spring means for applying spring force to the vibrating protrusion means.

According to another aspect of the present invention, there is provided a vibrating massager comprising: a vibration source; a vibrating member adapted to be vibrated by the vibration source; a sheet-like body disposed on one surface side of the vibrating member and having vibrating protrusions formed thereon; and compression springs provided for respectively corresponding vibrating protrusions so as to be in contact with an inner surface of the vibrating member and an inner surface of the sheet-like body.

According to a further aspect of the present invention, there is provided a vibrating massager comprising: a vibration source; a vibrating member adapted to be vibrated by the vibration source and having protrusion insertion holes formed through the vibrating member; vibrating protrusions each having a top portion and a body portion and each inserted through corresponding one of the protrusion insertion holes so that the top portions of each vibrating protrusion project out of corresponding one of the protrusion insertion holes; lock plates fixed to the base side of body portions of the vibrating protrusions respectively correspondingly; and tension springs each having one and the other ends and provided on the vibrating protrusions respectively so that the one end of each of the tension springs is fixedly attached to the lock plate of corresponding one of the vibrating protrusions and the other end of the tension spring is fixedly attached to an inner surface of the vibrating member in a vicinity of corresponding one of the protrusion insertion holes.

In the above vibrating massager, preferably, magnetic powder or a magnetic ball is disposed in each of the vibrating protrusion portions.

### BRIEF DESCRIPTION OF THE DRAWINGS

FIG. 1 is a perspective view of a vibrating massager shown as an embodiment according to the present invention;

FIG. 2 is a perspective view of the vibrating massager viewed from its bottom;

FIG. 3 is a main portion vertical sectional view of the vibrating massager, taken on line A-A in FIG. 2;

FIG. 4 is a main portion vertical sectional view of another embodiment of the vibrating massager according to the present invention; and

FIG. 5 is a main portion vertical sectional view of a further embodiment of the vibrating massager according to the present invention.

### DETAILED DESCRIPTION OF THE PREFERRED EMBODIMENTS

An embodiment of the present invention will be described below in detail with reference to the drawings.

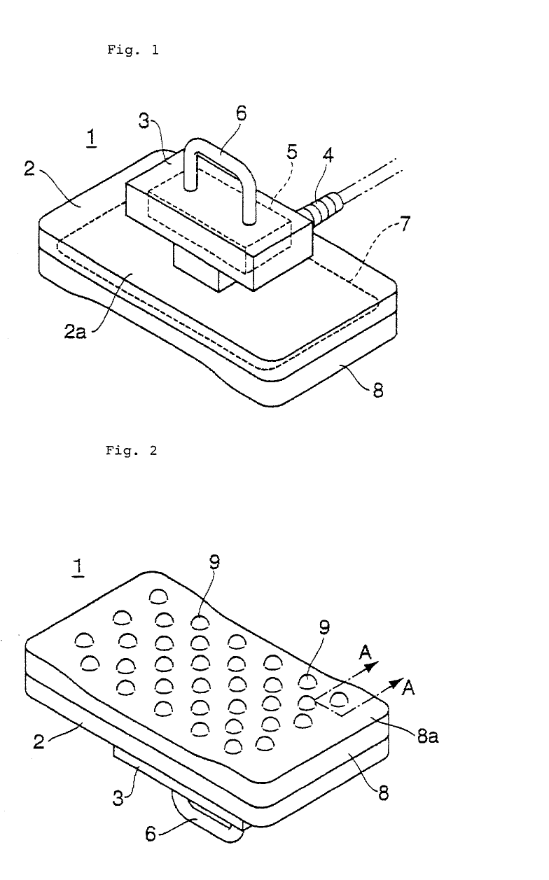

A vibrating massager 1 as an embodiment shown in FIGS. 1 to 3 has a casing 2 molded of synthetic resin or the like into a thin box-like shape which the bottom side is opened. A driving portion 3 is formed integrally with a top surface 2a of the casing 2.

A vibrator 5 is built in the inside of the driving portion 3, as a driving source which is to be connected to a power supply through a cord 4 though the details of the vibrator 5 are not shown in the drawing. Though not illustrated in the drawing, a power switch, a changeover switch for changing over the vibration strength of the vibrator 5, and so on, are provided in the driving portion 3. A grip 6 constituting a holding portion is provided on the driving portion 3.

A vibrating plate 7, which is a vibrating member driven by the vibrator 5, is provided in the casing 2 as shown in FIG. 1. Though not shown in the drawing, the outer circumferential portion of the vibrating plate 7 is supported by the casing 2, and the whole of the vibrating plate 7 is driven by the vibrator 5 so as to vibrate in the thickness direction. An elastic sheet-like body 8 is incorporated in the casing 2 so as to cover the opened bottom of the casing 2.

The elastic sheet-like body 8 is molded of flexible synthetic resin or hard synthetic rubber, and disposed in opposition to the vibrating plate 7. The outer circumferential portion of the elastic sheet-like body 8 is fixed to the inner circumferential portion of the casing 2. When the vibrating massager 1 is pressed against an affected part, as will be described later, the elastic sheet-like body 8 is elastically deformed in accordance with the form of the affected part.

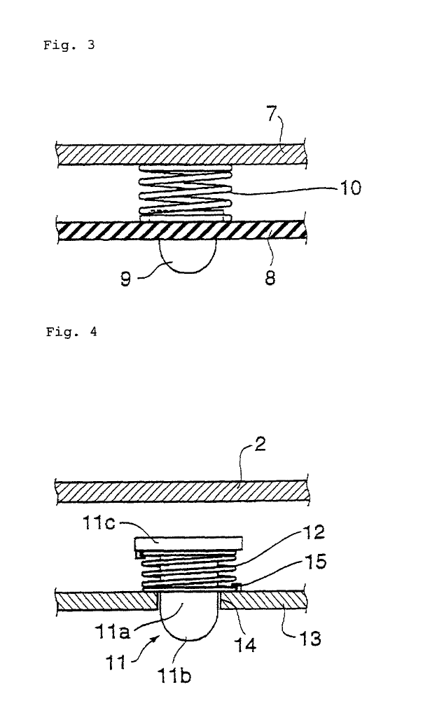

A large number of vibrating protrusions 9 are formed integrally with the elastic sheet-like body 8 so as to project from a main surface 8a of the elastic sheet-like body 8 as shown in FIG. 2. Each of the vibrating protrusions 9 is formed of a hemispherical convex portion as shown in FIG. 3. Incidentally, the shape of each of the vibrating protrusions 9 is not limited to such a hemispherical convex shape, and for example, it may be formed into a circular truncated cone or a circular cone.

A large number of helical compression springs 10 are provided in the casing 2 so as to be interposed between the vibrating plate 7 and the elastic sheet-like body 8 and located correspondingly to the vibrating protrusions 9 respectively. The opposite ends of the helical compression springs 10 are fixed to the vibrating plate 7 and the elastic sheet-like body 8 respectively, while the helical compression springs 10 are interposed between the vibrating plate 7 and the elastic sheet-like body 8 so as to be compressed when force acts thereon.

In the vibrating massager 1 configured thus, the vibrating plate 7 vibrates as soon as electric power is applied to the vibrator 5. In the vibrating massager 1, the vibration of the vibrating plate 7 is transmitted to the respective vibrating protrusions 9 through the respective helical compression springs 10. Thus, each of the vibrating protrusions 9 vibrates. According to the vibrating massager 1, a user grips the grip 6 by hand, and presses the elastic sheet-like body 8 against an affected part strongly so that the respective vibrating protrusions 9 vibrate to massage and relax the affected part.

In the vibrating massager 1, as mentioned above, the helical compression springs 10 are interposed between the vibrating plate 7 and the vibrating protrusions 9 respectively so that compression force is generated in the helical compression springs 10 due to the vibration of the vibrating plate 7. Therefore, according to the vibrating massager 1, the vibration of the vibrating plate 7 is transmitted to the vibrating protrusions 9 so that the vibrating pressure by the vibrating protrusions 9 is adjusted suitably. In addition, the vibrating protrusions 9 give stimulus to a pressure point more easily than a flat vibrating member.

As described above, the vibrating massager 1 is configured so that the elastic sheet-like body 8 is elastically deformed in accordance with the form of an affected part. Accordingly, the vibrating protrusions 9 can be pressed uniformly against the whole of the affected part. However, the present invention is not limited to such a configuration. The vibrating massager 1 may be, for example, designed so that the elastic sheet-like body 8 is vibrated directly by the vibrator 5. In this case, the elastic sheet-like body 8 is molded to be slightly thicker. Thus, the elastic sheet-like body 8 is elastically deformed in accordance with an affected part while the elastic sheet-like body 8 is caused by the vibrator 5 to perform vibration operation. In addition, according to the vibrating massager 1, the helical compression springs 10 are interposed between the inner surface of the elastic sheet-like body 8 and the inner surface of the casing 2 at places respectively corresponding to the vibrating protrusions 9.

Alternatively, as shown in FIG. 4, the vibrating massager 1 may be configured so that helical tension springs 12 are attached directly to vibrating protrusions 11 respectively and correspondingly. Each of the vibrating protrusions 11 is constituted by a columnar body portion 11a, a hemispherical pad portion 11b formed at the top portion of the body portion 11a, and a flange-like lock plate 11c formed on the body side of the body portion 11a. The aforementioned portions 11a, 11b and 11c are formed by integral molding with elastic material such as synthetic rubber or the like to thereby form each vibrating protrusion 11.

The vibrating massager 1 is assembled as follows. A plurality of protrusion insertion holes 14 are formed in the vibrating plate 13 which is a vibrating member, while hook portions 15 are formed on the inner surface of the vibrating plate 13 respectively correspondingly to the protrusion insertion holes 14. The vibrating plate 13 is formed of a thick sheet molded of elastic material such as synthetic resin, or a metal plate. The vibrating plate 13 is vibrated in the thickness direction by the vibrator 5.

The vibrating protrusions 11 are assembled to the vibrating plate 13 so that the pad portions 11b are exposed to the outside through the protrusion insertion holes 14, respectively. In the respective vibrating protrusions 11, the helical tension springs 12 are set to the outer circumferential portions of the body portions 11a respectively and correspondingly. Each of the helical tension springs 12 is interposed between the corresponding lock plate 11c and the vibrating plate 13 so that one end portion of the spring 12 is fixed to the lock plate 11c while the other end portion of the same is fixed to the corresponding hook portion 15 of the vibrating plate 13. Thus, the helical tension springs 12 expand when force acts between the lock plate 11c and the vibrating plate 13.

According to the vibrating massager 1 configured thus, when the vibrating plate 13 is driven to vibrate in a condition that the vibrating plate 13 is pressed against an affected part, the vibration of the vibrating plate 13 is adjusted by the helical tension springs 12. As a result, large vibration action and strong vibration pressure are produced in the respective vibrating protrusions 11 so that the vibrating massager 1 massages the affected part efficiently. The vibrating massager 1 can be designed so as to be made thinner as a whole due to the assembly of the helical tension springs 12 to the vibrating protrusions 11 respectively and correspondingly.

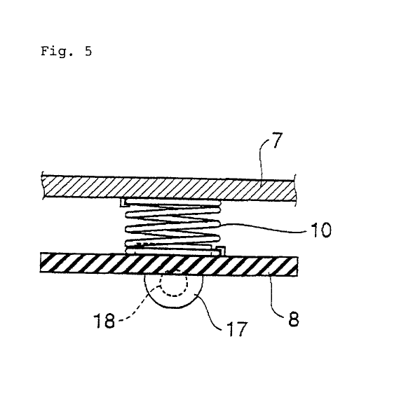

In the vibrating massager 1, a magnetic ball 18 may be buried in each of the vibrating protrusions 17 as shown in FIG. 5. The magnetic ball 18 is known to have an effect of applying magnetic line of force to an affected part to thereby improve the circulation of the blood. Each of the vibrating protrusions 17 is designed to have the magnetic ball 18 buried inside integrally by insert molding. The magnetic ball 18 may be magnetic powder.

In the condition that the magnetic massager 1 is pressed against an affected part, the vibrating protrusions 17 vibrate through the vibrating plate 7 and the helical compression springs 10 so as to massage and relax the affected part. At the same time, the magnetic line of force emitted from the magnetic balls 18 are applied to the affected part. Thus, in the vibrating massager 1 having the magnetic balls 18, the massage effect is improved by the magnetic line of force.

Incidentally, although the vibration of the vibrating member is adjusted by the helical springs in the aforementioned vibrating massager 1, not to say, other spring members or the like may be operated.

As has been described above in detail, in the vibrating massager according to the present invention, the vibration of the vibrating member can be adjusted the vibration of the vibrating protrusions through the springs. In addition, the vibrating protrusions can give stimulus to a pressure point easily.

What is claimed is:

1. A vibrating massager comprising:
a vibration source;
a vibrating member adapted to be vibrated by said vibration source;
vibrating protrusion means formed on one surface side of said vibrating member; and
spring means for applying spring force to said vibrating protrusion means.

2. A vibrating massager comprising:
a vibration source;
a vibrating member adapted to be vibrated by said vibration source;
a sheet-like body disposed on one surface side of said vibrating member and having vibrating protrusions formed thereon; and
compression springs provided for respectively corresponding vibrating protrusions so as to be in contact with an inner surface of said vibrating member and an inner surface of said sheet-like body.

3. A vibrating massager comprising:
a vibration source;
a vibrating member adapted to be vibrated by said vibration source and having protrusion insertion holes formed through said vibrating member;
vibrating protrusions each having a top portion and a body portion and each inserted through corresponding one of said protrusion insertion holes so that said top portions of each vibrating protrusion project out of corresponding one of said protrusion insertion holes;
lock plates fixed to the base side of said body portions of said vibrating protrusions respectively correspondingly; and
tension springs each having one and the other ends and provided on said vibrating protrusions respectively so that said one end of each of said tension springs is fixedly attached to said lock plate of corresponding one of said vibrating protrusions and the other end of said tension spring is fixedly attached to an inner surface of said vibrating member in a vicinity of corresponding one of said protrusion insertion holes.

4. A vibrating massager according to any one of claims 1 to 3, wherein magnetic powder or a magnetic ball is disposed in each of said vibrating protrusion portions.
